(19) United States
(12) Patent Application Publication
(10) Pub. No.: US 2007/0127654 A1
(43) Pub. Date: Jun. 7, 2007

(54) Caller ID display communication device applied to KSUless telephone system

(76) Inventors: Yang-Hsin Lin, Hsinchu (TW); Chun-Hung Chen, Hsinchu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/295,589

(22) Filed: Dec. 7, 2005

(51) Int. Cl. H04M 15/06; H04M 1/56

(52) U.S. Cl. 379/142.01

(57) ABSTRACT

A caller ID display communication device applied to a KSUless telephone system makes use of a caller ID display decoder to receive data of at least a telephone line. The data is decoded and then transmitted to a TDOV system, which processes the data into a TDOV data. Next, a processor is used to encode/decode this data and convert it to at least a set of caller ID information sent back to the TDOV system. Subsequently, a main telephone line supporting TDOV is used to transmit the caller ID information to at least a communication equipment and display the caller ID information on a display thereof. Through phase shift keying of the TDOV system and collocation of a communication equipment having a caller ID display circuit, each communication equipment in the telephone system can display the caller ID information without increasing the cost.

### BACKGROUND OF THE INVENTION

1. Field of the Invention

The present invention relates to a communication device with caller ID display function and, more particularly, to a caller ID display communication device applied to a KSUless telephone system (KSU: Key Service Unit)

2. Description of Related Art

With the progress of science and technology, electric appliances become more and more powerful. The functionality of most electric appliances is constantly enhanced toward the object of multiple functions. In addition to multiple functions, it is also necessary to meet the requirements of high maneuverability and low cost. Especially, because communication equipments such as telephones and mobile phones greatly reduce the distance between people, they become indispensable in everyday life of people.

Caller ID display is a basic function of modem telephones. As compared to telephones without the caller ID display function, the cost of telephones with the caller ID display function is higher since an extra caller ID display signal receiving circuit is required. If the caller ID display function is required for several tens of telephones or more in a company, it is necessary to provide the caller ID display signal receiving circuit for each telephone or to purchase telephones with the caller ID display signal receiving circuit. Moreover, it is necessary to install an exchange so that each telephone can display the caller's telephone number in real time. The cost of the telephone system will thus increase substantially.

Accordingly, the present invention aims to propose a caller ID display communication device applied to a KSUless telephone system to effectively solve the above problems in the prior art.

### SUMMARY OF THE INVENTION

An object of the present invention is to provide a caller ID display communication device applied to a KSUless telephone system, in which a high-end communication equipment having a caller ID display decoder is provided. Through the collocation of a time division multiple access over voice line (TDOV) system, caller ID information received by this high-end communication equipment can be displayed on other basic communication equipments with an inbuilt TDOV system.

Another object of the present invention is to provide a caller ID display communication device applied to a KSUless telephone system, in which a TDOV system is used so that basic telephones can display caller ID information in real time through the TDOV system.

Another object of the present invention is to provide a caller ID display communication device applied to a KSUless telephone system, in which a TDOV system makes use of phase shift keying to share data with other communication equipments.

To achieve the above objects, the present invention provides a caller ID display communication device applied to a KSUless telephone system, which comprises a caller ID display decoder for receiving and decoding data of at least a telephone line and then sending the data out, a TDOV system for processing the data sent out by the caller ID display decoder into a TDOV data, a processor for encoding/decoding and converting the data to at least a set of caller ID information and then sending the caller ID information back to the TDOV system so that the caller ID information can be separately transmitted to at least another communication equipment, and a display for displaying the caller ID information. Through phase shift keying of the TDOV system, each communication equipment in the telephone system can display the caller ID information without the need of an exchange and a caller ID display signal receiving circuit, hence not increasing the cost.

### BRIEF DESCRIPTION OF THE DRAWINGS

The various objects and advantages of the present invention will be more readily understood from the following detailed description when read in conjunction with the appended drawing, in which:

FIG. 1 is an architecture diagram of a high-end telephone having a caller ID display decoder and a TDOV system of the present invention; and

FIG. 2 is a diagram of a caller ID display communication device applied to a KSUless telephone system of the present invention.

### DETAILED DESCRIPTION OF THE PREFERRED EMBODIMENTS

The present invention provides a caller ID display communication device applied to a KSUless telephone system (KSU: Key Service Unit), in which a time division multiple access over voice line (TDOV) system is installed on each telephone of a telephone system to make it a KSUless telephone system. A high-end telephone having a caller ID display decoder in the telephone system is then set as a caller ID display communication device to allow other telephones to display caller ID information by using the TDOV system.

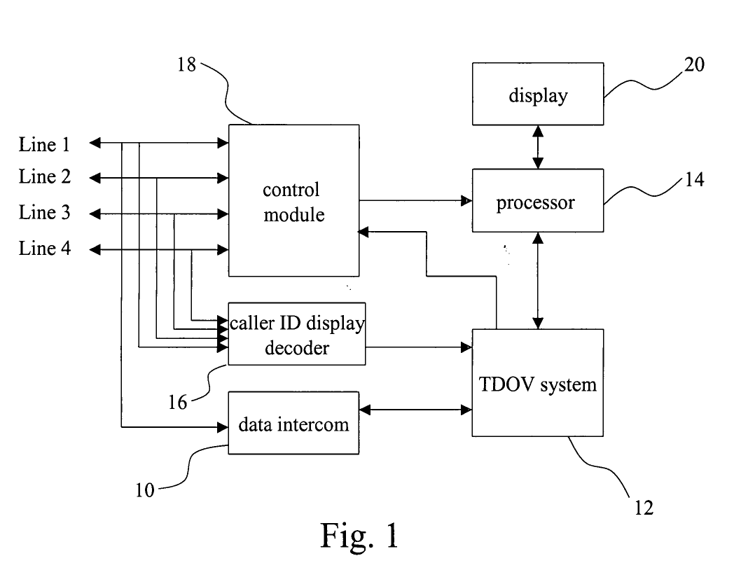

As shown in FIG. 1, the caller ID display communication device comprises a plurality of telephone lines, in this embodiment, there are four telephone lines-Line 1, Line 2, Line 3 and Line 4, wherein Line 1 is the main telephone line. In addition to having the function of an ordinary telephone line, Line 1 can also transmit data of the TDOV system. Line 2 to Line 4 are ordinary telephone lines ; A data intercom 10, which is used to receive and transmit data of the main telephone line (i.e., Line 1) to a TDOV system 12, or to receive messages sent back by the TDOV system 12 and transmit the messages to Line 1. The TDOV system 12 makes use of phase shift keying to process the received digitized voice or data signals into a TDOV data. A processor 14 encodes/decodes and converts the data to caller ID information. Finally the caller ID information is displayed on the display 20

The caller ID display communication device also comprises a control module 18, which is used to handle the functions of an ordinary telephone like dialing/answering, waiting and forwarding. When any one of Line 1 to Line 4 receives a signal, the signal is directly transmitted to the processor 14 via the control module 18.

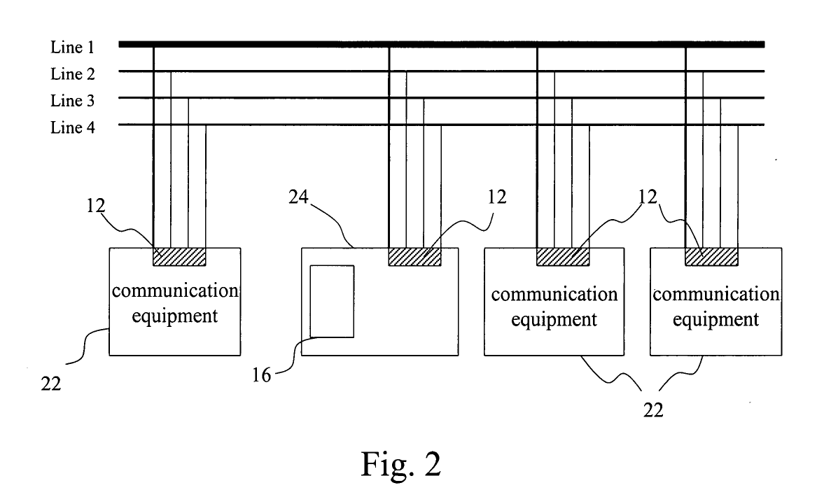

FIG. 2 is a diagram of a caller ID display communication device applied to a KSUless telephone system of the present invention. There are four telephone lines in this KSUless telephone system. Data modulated by the TDOV system 12 is transmitted via Line 1. Line 2 to Line 4 are ordinary telephone lines. The three communication equipments 22 can be ordinary basic telephone sets with no caller ID display signal receiving circuit but with a display screen. The caller ID display communication device 24 can be a high-end telephone set having an inbuilt caller ID display decoder 16 and with the caller ID display function. A TDOV system 12 is disposed on each of the basic communication equipments 22 and the high-end caller ID display communication device 24.

Reference is made to FIG. 1 as well as FIG. 2. When there is an incoming call regardless of any one of Line 1 to Line 4, the signal will be transmitted to the caller ID display decoder 16 in the caller ID display communication device 24. The TDOV system 12 then performs phase shift keying to the signal. Next, the data intercom 10 transmits data from Line 1 into the other three communication equipments 22. Finally, information like the caller's telephone number and the telephone line number will be displayed on the display 20. Therefore, when there is an incoming call, all the communication equipments 22 and the caller ID display communication device 24 will ring. When there are two or more incoming calls, the display 20 will display the caller ID information in the order of priority of the incoming calls. A key can be pressed to view the caller ID information of the first incoming call again.

To sum up, the present invention provides a caller ID display communication device applied to a KSUless telephone system, in which a TDOV system performs phase shift keying to digitized voice or data. The processed voice or data is then transmitted to other telephone sets via existent telephone lines to accomplish multiple access, multiple channels and resource sharing. When there is an incoming call, a high-end telephone set having a caller ID display decoder is used as a server to simultaneously display information like the caller's telephone number on screens of other telephone sets in the telephone system. It is not necessary to provide an extra exchange, and a caller ID display signal receiving circuit is not required for each telephone set, hence substantially lowering the cost.

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are intended to be embraced within the scope of the invention as defined in the appended claims.

I claim:

1. A caller ID display communication device applied to a KSUless telephone system, comprising:
a caller ID display decoder for receiving, decoding and then sending out data of at least a telephone line;
a time division multiple access over voice line (TDOV ) system for processing said data sent out by said caller ID display decoder into a TDOV data;
a processor for encoding/decoding and converting said data to at least a set of caller ID information, and then sending said caller ID information back to said TDOV system so that said caller ID information can be separately transmitted to at least another communication equipment; and
a display for displaying said caller ID information.

2. The caller ID display communication device applied to a KSUless telephone system as claimed in claim 1, wherein said caller ID information includes a caller's telephone number and a telephone line number.

3. The caller ID display communication device applied to a KSUless telephone system as claimed in claim 1, wherein said TDOV system can also display said caller ID information on a display of at least another communication equipment.

4. The caller ID display communication device applied to a KSUless telephone system as claimed in claim 1, wherein said communication equipments can further achieve internal communication via said TDOV system.

5. The caller ID display communication device applied to a KSUless telephone system as claimed in claim 1, wherein when there are more than two incoming calls, said display will display said caller ID information in the order of priority of the incoming calls, and a key can be pressed to view said caller ID information of the first incoming call again.

6. The caller ID display communication device applied to a KSUless telephone system as claimed in claim 1, wherein said caller ID information is transmitted to a main telephone line supporting TDOV via a data intercom and then transmitted into said communication equipment via said main telephone line.

7. The caller ID display communication device applied to a KSUless telephone system as claimed in claim 1, further comprising a control module, wherein said control module is used to control the telephone function of a house telephone.

8. The caller ID display communication device applied to a KSUless telephone system as claimed in claim 6, wherein said TDOV system makes use of phase shift keying to transmit data to said communication equipment via said main telephone line accomplish internal communication and sharing of said caller ID information.
